(19) United States
(12) Patent Application Publication
(10) Pub. No.: US 2022/0029815 A1
(43) Pub. Date: Jan. 27, 2022

(54) STREAMING CONTENT VIA BLOCKCHAIN TECHNOLOGY

(71) Applicant: 0Chain Corp., Cupertino, CA (US)

(72) Inventors: Saswata Basu, Cupertino, CA (US); Thomas Howard Austin, San Jose, CA (US)

(21) Appl. No.: 17/497,902

(22) Filed: Oct. 9, 2021

Related U.S. Application Data
(63) Continuation-in-part of application No. 17/349,815, filed on Jun. 16, 2021.
Application No. 17/349,815 is a continuation-in-part of application No. 15/994,946, filed on May 31, 2018, now Pat. No. 11,165,862.
Application No. 15/994,946 is a continuation-in-part of application No. 17/307,073, filed on May 4, 2021.
Application No. 17/307,073 is a continuation-in-part of application No. 16/247,994, filed on Jan. 15, 2019, now Pat. No. 11,171,791.
Application No. 16/247,994 is a continuation-in-part of application No. 16/213,360, filed on Dec. 7, 2018.
Application No. 16/213,360 is a continuation-in-part of application No. 17/349,748, filed on Jun. 16, 2021.
Application No. 17/349,748 is a continuation-in-part of application No. 17/349,779, filed on Jun. 16, 2021.
Application No. 17/349,779 is a continuation-in-part of application No. 17/349,833, filed on Jun. 16, 2021.
(60) Provisional application No. 62/707,177, filed on Oct. 24, 2017.

(51) Int. Cl. H04L 9/32; H04L 9/08; H04L 29/06

(52) U.S. Cl. CPC H04L 9/3236; H04L 65/601; H04L 65/608; H04L 9/0836

(57) ABSTRACT

An approach is disclosed for streaming content into a plurality of blobbers running on a blockchain storage platform. The streaming content is received, and the content is stored into a buffer. The buffered content is separated into fragments F (F1, F2, . . . , Fi, . . . , Fj . . . , Fn) where the each fragment Fi has a memory allocation different from other fragments Fj where j is not i while continuing to receive the streaming content until a blocking event occurs. Each fragment is split into a number of chunks determined by a fragment size divided by a chunk size. Each chunk is split into a fixed number of DABs where the number of DABs is the chunk size divided by the DAB size. A fixed Merkle tree is constructed suitable for sending to a number of blobbers for recording the DABs referenced by the leaf nodes of the fixed Merkle tree.

If an Application Data Sheet (ADS) has been filed for this application, it is incorporated by reference herein. Any applications claimed on the ADS for priority under 35 U.S.C. §§ 119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC § 119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

For purposes of the USPTO extra-statutory requirements, the present application constitutes a utility application related to and claims the benefit of priority from U.S. Provisional Patent Application No. 62/707,177 filed on Oct. 24, 2017.

### BACKGROUND

The present invention relates to a computing environment, and more particularly streaming content utilizing blockchain technology.

### SUMMARY

According to one embodiment of the invention, there is provided a method of streaming content into one or more blobbers in a blockchain platform. A method that includes a processor and a local storage device accessible by the processor for streaming content into a blockchain platform. Streaming content C (C1, C2, . . . , Ci, Ci+1, . . . ) is received into buffers in the blockchain platform. The buffered content is separated into fragments F (F1, F2, . . . , Fn) where the each fragment Fi has a memory allocation different from other fragments Fj where j is not i while continuing to receive the streaming content until a blocking event occurs. Each fragment is split into a number of chunks determined by a fragment size divided by a chunk size. Each chunk is split into a fixed number of DABs where the number of DABs is the chunk size divided by the DAB size. A fixed Merkle tree is constructed suitable for sending to a number of blobbers for recording the DABs referenced by the leaf nodes of the fixed Merkle tree.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 illustrates an embodiment of a blockchain system according to the present disclosure;

FIG. 2 depicts an embodiment of a client device;

FIG. 3 depicts an embodiment of a miner system;

FIG. 4 depicts an embodiment of a blobber system;

FIG. 5 depicts a flow of a process that streams content to a client;

FIG. 6 depicts an embodiment supporting pushing a live stream to a blobber/blockchain;

FIG. 7 depicts an overview of an embodiment supporting streaming synchronizing to blockchain/blobbers,

FIG. 8 depicts an overview of processing a block of data into a fixed Merkle tree;

FIG. 9 depicts an overview of an embodiment for calculating a Merkle root for a large, streaming file;

FIG. 10 shows the steps taken by a process of an embodiment that calculate the Merkle root for a large, streaming file;

FIG. 11 shows the steps taken by finalize( ), a process that finalizes a Merkle tree;

FIG. 12 depicts an embodiment of a process handling blockchain streaming storage

FIG. 13 depicts a process that assures blockchain storage reliability; and

FIG. 14 depicts a schematic view of a processing system wherein the methods of this invention may be implemented.

### DETAILED DESCRIPTION

Blockchain technology, sometimes also referred to as “blockchain,” is a particular type of distributed database. Blockchains can theoretically be used to store any type of data or content, but are particularly well-suited to environments in which transparency, anonymity, and verifiability are important considerations. Examples include financial projects, such as cryptocurrencies, auctions, capital management, barter economies, insurance lotteries, and equity crowd sourcing.

A blockchain, originally block chain, is a growing list of records, called blocks, that are linked using cryptography. Each block contains a cryptographic hash of the previous block, a timestamp, and transaction data (generally represented as a Merkle tree). The Merkle tree is a hash-based data structure that is a generalization of the hash list. It is a tree structure in which each leaf node is a hash of a block of data, and each non-leaf node is a hash of its children. Typically, Merkle trees have a branching factor of 2, meaning that each node has up to 2 children.

By design, a blockchain is resistant to modification of its data. This is because once recorded, the data in any given block cannot be altered retroactively without alteration of all subsequent blocks. For use as a distributed ledger, a blockchain is typically managed by a peer-to-peer network collectively adhering to a protocol for inter-node communication and validating new blocks. Although blockchain records are not unalterable, blockchains may be considered secure by design and exemplify a distributed computing system with high Byzantine fault tolerance. A Byzantine fault is a condition of a computer system, particularly distributed computing systems, where components may fail and there is imperfect information on whether a component has failed. The blockchain has been described as “an open, distributed ledger that can record transactions between two parties efficiently and in a verifiable and permanent way.”

The technology is perhaps most easily understood through a simple and familiar example, such as “Bitcoin,” a cryptocurrency. A cryptocurrency is not entirely dissimilar from conventional currencies and, like a traditional currency, is essentially a medium of exchange. Traditional currencies are represented by a physical object paper currency or minted coins, for example—which is “spent” by physically delivering it in the proper denominations to a recipient in exchange for a good or service.

However, for long-distance transactions, such as buying goods or services over the Internet, direct physical delivery is not feasible. Instead, the currency would have to be mailed to the recipient. However, this carries a very high risk of fraud. The recipient may simply keep the money and not deliver the purchased good or service, leaving the buyer without recourse. Instead, on-line transactions are typically carried out using electronic payment systems in which the transaction is processed, validated, and mediated by a trusted third party. This third party may be a bank, as in the case of a debit or credit card, or a third-party service functioning as an escrow agent, such as PayPal. Crypto currencies operate on this same principle, except that instead of using a financial institution or other third party to facilitate the transaction, the transaction is verified through a consensus reached via cryptographic proof.

Internet is a global computer network providing a variety of information and communication facilities, comprising interconnected networks using standardized communication protocols. Internet is not owned by a single entity and it operates without a central governing body. The same principles of distributed governance were applied to digital currencies by providing ability to perform digital transactions that existed without support from any underlying institution. The digital ledger that records the transactions in a chain using a mathematical hierarchy is called a blockchain.

The current blockchain platform and related applications known to the industry fall short in multiple ways. First, there is no separation of roles on the blockchain based on the role of an entity for a given transaction. Each transaction follows a strict chain of rules and is dependent on its preceding transaction. If one transaction fails, all subsequent transactions on the blockchain become unusable. The computing time and built-in delay in any blockchain platform is dependent on the available computing resources of its nodes. In absence of a role model, a single node has several computing intense tasks that are slow to execute. A slow system becomes vulnerable and becomes open to attacks. The current solutions do not allow for client flexibility in developing distributed applications with immutability and finality of transactions on a blockchain platform.

In order to overcome the deficiencies of the prior art, various methodologies are disclosed where an infrastructure is supplied to enable usage of the disclosed methodology. In an embodiment, application programming interfaces (API) are provided to handle the details where examples are available on the 0chain platform. For this disclosure, high level descriptions of the details are discussed which should be adequate for those with ordinary skill in the art to implement solutions. In this disclosure, support for the identified features may be identified as modules in the blockchain platform with embodiments as described herein embedded in the modules.

The following definitions generally apply to this disclosure and should be understood in both the context of client/server computing generally, as well as the environment of a blockchain network. These definitions, and other terms used herein, should also be understood in the context of leading white papers pertaining to the subject matter. These include, but are not necessarily limited to, Bitcoin: A Peer-to-Peer Electronic Cash System (Satoshi Nakamoto 2008). It will be understood by a person of ordinary skill in the art that the precise vocabulary of blockchains is not entirely settled, and although the industry has established a general shared understanding of the meaning of the terms, reasonable variations may exist.

The term “network” generally refers to a voice, data, or other telecommunications network over which computers communicate with each other. The term “server” generally refers to a computer providing a service over a network, and a “client” generally refers to a computer accessing or using a service provided by a server over a network. The terms “server” and “client” may refer to hardware, software, and/or a combination of hardware and software, depending on context. The terms “server” and “client” may refer to endpoints of a network communication or network connection, including but not necessarily limited to a network socket connection. A “server” may comprise a plurality of software and/or hardware servers delivering a service or set of services. The term “host” may, in noun form, refer to an endpoint of a network communication or network (e.g., “a remote host”), or may, in verb form, refer to a server providing a service over a network (“hosts a website”), or an access point for a service over a network. It should be noted that the term “blockchain network” as used herein usually means the collection of nodes interacting via a particular blockchain protocol and ruleset. Network nodes are the physical pieces that make up a network. They usually include any device that both receives and then communicates information. But they might receive and store the data, relay the information elsewhere, or create and send data instead.

The term “asset” means anything that can be owned or controlled to produce value.

The term “asymmetric key encryption,” also known as “public key encryption,” “public key cryptography,” and “asymmetric cryptography,” means a cryptographic system that uses pairs of mathematically related keys, one public and one private, to authenticate messages. The “private key” is kept secret by the sending of a message or document and used to encrypt the message or document. The “public key” is shared with the public and can be used to decrypt the message or document.

The term “ledger” means the append-only records stored in a blockchain. The records are immutable and may hold any type of information, including financial records and software instructions.

The term “blockchain” means a distributed database system comprising a continuously growing list of ordered records (“blocks”) shared across a network. In a typical embodiment, the blockchain functions as a shared transaction ledger.

The term “transaction” means an asset transfer onto or off of the ledger represented by the blockchain, or a logically equivalent addition to or deletion from the ledger.

The term “blockchain network” means the collection of nodes interacting via a particular blockchain protocol and rule set.

The term “nonce” means an arbitrary number or other data used once and only once in a cryptographic operation. A nonce is often, but not necessarily, a random or pseudorandom number. In some embodiments, a nonce will be chosen to be an incrementing number or time stamp which is used to prevent replay attacks.

The term “block” means a record in a continuously growing list of ordered records that comprise a blockchain. In an embodiment, a block comprises a collection of confirmed and validated transactions, plus a nonce.

The term “hash” means a cryptographic algorithm to produce a unique or effectively unique value, properly known as a “digest” but sometimes informally referred to itself as a “hash,” usually from an arbitrary, variable-sized input. Hashes are repeatable and unidirectional, meaning the algorithm always produces the same digest from the same input, but the original input cannot be determined from the digest. A change to even one byte of the input generally results in a very different digest, obscuring the relationship between the original content and the digest. SHA256 (secure hash algorithm) is an example of a widely used hash.

The term “mining” means the process by which new transactions to add to the blockchain are verified by solving a cryptographic puzzle. In a proof-of-work blockchain network, mining involves collecting transactions reported to the blockchain network into a “block,” adding a nonce to the block, then hashing the block. If the resulting digest complies with the verification condition for the blockchain system (i.e., difficulty), then the block is the next block in the blockchain.

The term “miner” refers to a computing system that processes transactions. Miners may process transactions by combining requests into blocks. In embodiments, a miner has a limited time, for example, 15-50 milliseconds, to produce a block. Not all miners generate blocks. Miners that generate blocks are called “generators.” Miners may be ranked and chosen to perform transactions based on their ranking. Some limited number of miners may be chosen to perform validation. All miners must be registered on the blockchain. The mining process involves identifying a block that, when hashed twice with SHA256 yields a number smaller than the given difficulty target. While the average work required increases in inverse proportion to the difficulty target, a hash can always be verified by executing a single round of double SHA-256. For the bitcoin timestamp network, a valid proof-of-work is found by incrementing a nonce until a value is found that gives the block's hash the required number of leading zero bits. Once the hashing has produced a valid result, the block cannot be changed without redoing the work. As later blocks are chained after it, the work to change the block would include redoing the work for each subsequent block. Majority consensus is represented by the longest chain, which required the greatest amount of effort to produce. If a majority of computing power is controlled by honest nodes, the honest chain will grow fastest and outpace any competing chains. To modify a past block, an attacker would have to redo the proof-of-work of that block and all blocks after it and then surpass the work of the honest nodes. The probability of a slower attacker catching up diminishes exponentially as subsequent blocks are added.

Messages representing generated blocks are sent to all miners by identifying the block with a block hash, transaction hash, and a signature of the minor producing the block. The miners receiving the messages replay the transactions for the block and sign an authentication message. If there are enough miners authenticating the block, consensus ticket it signed. In some embodiments a ⅔+1 agreement or 67% agreement is needed to generate the consensus ticket.

The term “sharding” is a technique in blockchain that seeks to achieve scalability within a blockchain network. The process of sharding seeks to split a blockchain network into separate shards, that contain their own data, separate from other shards.

The term “sharder” refers to a computing system that that keeps tracks of its blockchain history. They are a single source of truth regarding any given transaction.

The term “transaction fee” means a fee imposed on some transactions in a blockchain network. The amount of the transaction fee is awarded to the miner who successfully mines the next block containing that transaction.

The term “wallet” means a computer file or software of a user that allows a user of a blockchain network to store and spend cryptocurrency by submitting transactions to the blockchain network. A wallet is usually itself protected by cryptography via a private key.

The term “consensus” refers to a computational agreement among nodes in a blockchain network as to the content and order of blocks in the blockchain.

The term “digital signature” means a mathematically-based system for demonstrating the authenticity of a message or document by ensuring that it was sent from the identified sender and not tampered with by an intermediary. Blockchains generally use asymmetric key encryption to implement digital signatures.

The term “fork” means a split in a blockchain where two different valid successor blocks have been mined and are present in the blockchain, but consensus has not yet been reached as to which fork is correct. This type of fork is also referred to as a “soft fork,” and is automatically resolved by consensus over time. A “hard fork” is the forced imposition of a fork by manual intervention to invalidate prior blocks/transactions, typically via a change to the blockchain rules and protocol.

The term “cryptocurrency” (or “crypto”) is a digital currency that can be used to buy goods and services, but uses an online ledger with strong cryptography to secure online transactions. Much of the interest in these unregulated currencies is to trade for profit, with speculators at times driving prices skyward. There are currently many different types of cryptocurrencies offered by many different blockchain implementations. The usage of any given cryptocurrency may be represented herein as “tokens.”

The term “genesis block” means the very first block in a blockchain, that is, the root of the Merkle tree.

The term “proof-of-stake” means a mining system in which the production and verification of a block is pseudo-randomly awarded to a candidate miner, or prioritized list of candidate miners, who have invested a valuable stake in the system which can be collected by the blockchain network if the produced block is later deemed invalid. The stake functions as a deterrent against fraudulent blocks.

The term “proof-of-work” means a mining system in which the difficulty of finding a nonce that solves the cryptographic puzzle is high enough that the existence of a block compliant with the verification rules is itself sufficient proof that the block is not fraudulent.

The term “smart contracts” means computer programs executed by a computer system that facilitate, verify, or enforce the negotiation and performance of an agreement using computer language rather than legal terminology. Smart contracts may be verified and executed on virtual computer systems distributed across a blockchain.

The terms “web,” “web site,” “web server,” “web client,” and “web browser” refer generally to computers programmed to communicate over a network using the Hypertext Transfer Protocol (“HTTP”), and/or similar and/or related protocols including but not limited to HTTP Secure (“HTTPS”) and Secure Hypertext Transfer Protocol (“SHTP”). A “web server” is a computer receiving and responding to HTTP requests, and a “web client” is a computer having a user agent sending and receiving responses to HTTP requests. The user agent is generally web browser software.

The terms “erasure code” is a forward error correction (FEC) code under the assumption of bit erasures (rather than bit errors), which transforms a message of k symbols into a longer message (code word) with n symbols such that the original message can be recovered from a subset of the n symbols. The fraction r=k/n is called the code rate.

The term “database” means a computer-accessible, organized collection of data, which may be referred to as “content” in this document. Databases have been used for decades to format, store, access, organize, and search data. Traditionally, databases were stored on a single storage medium controlled by a single computer processor, such as a fixed disk or disk array. However, databases may also be organized in a “distributed” fashion, wherein the database is stored on a plurality of storage devices, not all of which are necessarily operated by a common processor. Instead, distributed databases may be stored in multiple component parts, in whole or part, dispersed across a network of interconnected computers. “difficulty” means proof-of-work mining, or the expected total computational effort necessary to verify the next block in a blockchain. Difficulty is generally determined by the verification rules of the blockchain and may be adjusted over time to cause the blockchain to grow (e.g., new blocks to be verified and added) at a desired rate. For example, in the Bitcoin blockchain network, the difficulty adjusts to maintain a block verification time of about ten minutes across the blockchain network.

It will be understood by one of ordinary skill in the art that common parlance in the computing industry refers to a “user” accessing a “site.” This usage is intended to represent technical access to an online server by a user via a user computer. That is, the reference to a “user” accessing a “server” refers to the user manipulating or otherwise causing client software to communicate over a telecommunications network with server software. This also typically means that the user's client software is running on a client computer system and accessing the server computer system remotely. Although it is possible that a user may directly access and use the server via the server hardware, and without use of a client system, this is not the typical use case in a client/server architecture.

The systems and methods described herein enable a user in a rewards or points-based system implemented via a blockchain network, to purchase a content according to terms of a smart contracts. Users can receive, store, and share or send rewards on-demand in exchange for receiving the content. However, the user need not directly use, or even be aware of, the underlying blockchain.

Described herein are systems and methods for an on-line, verifiable payment system that facilitates both manual and automatic payment with transaction costs as small as fractions of a cent. The systems and methods include a financial accounting system that uses smart contract technology and a centralized authority performing blockchain transactions on behalf of multiple independent users, and using bulk processing of transactions to reduce substantially the associated transaction fees, in some cases to fractions of a penny.

One key distinction of the disclosed data storage system from other blockchain storage solutions is the separation of the role of mining from that of providing storage. Computers that provide storage are referred to as blobbers. Blobbers are neither responsible nor required to perform mining. In this manner, the load is lightened on the mining network and enables fast transactions on a lightweight blockchain. As the client and blobber interact, the client generates special signed receipts called markers. These markers act like checks that the blobber can later cash in with the blockchain.

Once the interaction between client and blobber has concluded, the blobber writes an additional transaction to the blockchain, which redeems the markers for tokens, that is, the platform cryptocurrency, and commits the blobber to a Merkle root matching the data stored. The leaves of the Merkle tree must match markers sent from the client, preventing either the client or the blobber from defrauding each other.

After a file has been stored, a challenge protocol ensures both that the blobber continues to store the file and continues to be paid for that work. The mining network posts a transaction, challenging the blobber to prove that it still possesses the data that it was paid to store. The blobber must provide that data, the relevant system metadata, and the client-signed marker to prove that the right data is stored. The blobber is then rewarded or punished accordingly.

With the disclosed design, the majority of the work between clients and blobbers happens off-chain. The mining network is only involved enough to ensure that clients pay blobbers for their work and that the blobbers are doing the work that they have been paid to do. This approach assumes that the client is using erasure codes to ensure greater resiliency. While this is not a strict requirement, it does enable a client to recover if a blobber proves to be unreliable.

In an embodiment, the split-key wallet protocol uses a Boneh-Lynn-Shacham (BLS) signature scheme that is based on bi-linear pairings. A pairing, defined as e(,), is a bilinear map of 2 groups G1 and G2 in some other group, GT. e(,) takes e as arguments points in G1 and G2.

Pairings that verifies a signature have the form: e(g1, sig)=e(pk, H(m)) (in expanded form: e(g1, sk*H(m))=e(sk*g1, H(m))=e(g1, sk*H(m)) H(m) is hashing a message to a point on an elliptic curve.

BLS has:
KeyGen—choose a random α. Given generator g1, pk=α*g1
Sign—σ=α*H(m)∈G2 (in the case of eth2.0)
Verify(pk,m, σ)—if e(g1, σ)=e(pk, H(m)) return true.

The BLS signature scheme may be used to split keys and let users interact using crypto keys via a blockchain. Since the cryptocurrency balance is maintained against these keys, it's very important to protect the private key. The private key is split into two secondary keys, storing each of the secondary key on a different device. Signing requires individual signatures from each device. Hence, losing any one device can still protect the primary key. In addition, if desired, one of the secondary keys can be further split into two parts; only one of which is stored on the device and the other may be a simple PIN that the user has to enter each time. This provides an extra layer of protection in case both devices are compromised. The split-key wallet protocol makes it easy to generate as many split keys as desired providing the ability for the user to periodically rotate the split keys and in the process change the PIN.

With cryptocurrency, some quantity of tokens may be locked. In an embodiment, support may be provided for selling the cryptocurrency by specifying a name for locks, keys to the locks, how long each key is valid (from seconds to centuries), a number of keys, a price of the keys. Tokens acquired may be “locked” for the time each key is valid.

When clients lock tokens, they are rewarded with an “interest.” The interest is newly generated crypto-currency tokens, intended (but not required) for payment of services on the network. These services can be miner compensation for transaction processing, blobber compensation for storage, or transmitted to any other client in exchange for a service; facilitating a lucrative market for building and running distributed applications. In the event of network congestion, a client may also offer to lock a greater number of tokens to ensure that their transaction is accepted by the mining network. The token reward protocol creates an economy where the tokens can be used to receive services for “free”—meaning, the client does not lose their initial stake, but still adequately compensates the service provider.

The systems and methods of a blockchain platform for distributed applications includes separation of roles for a miner and a blobber. The message flow model between different parties including a client, a blobber and a miner allows for fast transactions on a lightweight blockchain by lightening the load on a mining network, i.e. a network of one or more miners. Offloading the work to a different group of machines allows for greater specialization in the design and specifications of the machines, allowing for the blockchain platform miners to be optimized for fast transaction handling and blockchain platform blobbers to be efficient at handling data for given transaction types.

In one embodiment, the distributed application is a storage application. Users of the system can request and get storage access without relying on a single source. While the distributed application described herein in detail is a storage application, a person of ordinary skill in the art would understand and apply the same invention disclosure on different types of distributed applications. The use of a distributed storage application is exemplary and not limiting in anyways the scope of the invention.

In one embodiment, a storage protocol applied on the blockchain platform relies on the miners to serve as intermediaries in all storage transactions. Furthermore, the blockchain platform may enforce strict requirements on blobbers and blobbers' machines to ensure a fast and lightweight response time and execution.

In one embodiment, data integrity of the transaction is verified by using hash of a file's contents. In another embodiment, the data is fragmented in two or more parts and each data part is separately hashed to create a Merkle tree. In one embodiment, the entire Merkle tree is stored and probabilistically verified. In another embodiment, the miners store the Merkle root of the stored files.

The role-based distributed execution using a message flow model on a blockchain platform allows for a flexible and robust model with feedback and evaluation of different parties based on past interactions. For example, the blockchain platform involves interaction between two or more clients, who have data that they wish to store, and blobbers who are willing to store that data for a fee. Neither the client nor the blobber necessarily trust one another, so transactions are posted to a blockchain produced by a trusted network of miners, i.e., a trusted mining network.

Players. The blockchain platform using a message flow model for role-based distributed work seeks to minimize the load on the mining network, so miners are not directly involved in the file transfer between clients and blobbers. Nonetheless, the transactions posted to the blockchain assures clients that their data is stored and gives blobbers confidence that they will be paid for their service; if either party misbehaves, the blockchain platform has the information to help identify cheaters.

Each client includes an application responsible for encrypting the data. The blockchain platform relies on erasure coding, which is also performed by the client. Clients are assumed to have a public/private key pair and a certain number of tokens. Erasure coding is a method of data protection in which data is broken into fragments, expanded and encoded with redundant data pieces and stored across a set of different locations or storage media. A miner works on a central chain of the blockchain platform. For example, in the context of storage, miners are responsible for accepting requests from clients, assigning storage to blobbers, locking client tokens to pay for their storage, and testing that blobbers are actually providing the storage that they claim. A blobber is responsible for providing long-term storage. Blobbers only accept requests that have been approved by the mining network, which helps to prevent certain attacks. Blobbers are paid in three ways: (i) When data is read from them, the clients give them special markers that the blobber can redeem for tokens; (ii) When client writes data to them, blobbers get special markers; and (iii) whenever a blobber is storing data, they are randomly challenged to provide special blocks and if these challenges are passed, the mining network rewards the blobber with tokens.

Protocol Sketch. For example, one basic message flow model based on roles on a blockchain platform for a distributed storage application can be broken into five parts. First, clients must use tokens to reserve system resources. These resources include the amount of storage, the number of reads, and the number of writes needed for the data. The client's tokens are locked for a set period of time. Once the time has elapsed, the client regains their tokens and loses their storage resources. Of course, a client may decide to re-lock their tokens to maintain their resources, though the number of tokens needed may change depending on the economy.

When clients want to use the resources that they have purchased, they must write a transaction to the network declaring their intent. The mining network connects the clients with the appropriate blobbers and allows them to set up a secure connection.

Once the connection is established, the mining network no longer acts as an intermediary between the client and the blobbers. During this phase, the client generates markers to give to the blobber in exchange for access to system resources. The blobber collects these markers and redeems them with the mining network once the transaction is complete; this transaction also notifies the blobber that the transaction has finished, and lets the network know that the miner and blobber agree on the data that the blobber is expected to store. In one embodiment, the markers help resolve disputes in case the client and blobber do not agree on the Merkle root.

After the blobber has completed the transaction, the mining network will periodically challenge the blobber to provide a randomly chosen block of data. These challenges involve a carrot and stick approach; blobbers are punished if they fail the challenge, and blobbers are rewarded with additional tokens when they pass the challenge. The blockchain platform ensures that blobbers are paid even when the data is not frequently accessed. When the client no longer wishes to store a file, they issue a deletion transaction to the network. Once it is finalized, blobbers delete the file and clients may use their storage allocation to store other files.

Error and Repair. One or more error reporting protocols and/or repair protocols work with the basic message flow model based on roles on a blockchain platform for a distributed storage application. In one embodiment, the error reporting protocol allows both clients and blobbers to report problems to the network. These problems could include either reports of when other clients or blobbers are acting maliciously, or when a system fails or drops from the network unexpectedly.

In one embodiment, a repair protocol arises when a blobber is identified as malicious, drops from the network, or is no longer considered suitable for storing the data that it has. When needed, the client can read the data from the network, reconstruct the missing fragment of data, and re-upload it to the network. In one embodiment, the mining network reconstructs a missing slice of the data from any other available slices without involving the client.

Attacks. The message flow model for the blockchain platform is robust and resilient to different types of attacks. For example, an outsourcing attack arises when a blobber claims to store data without actually doing so. The attacker's goal in this case is to be paid for providing more storage than is actually available. For example, if Alice is a blobber paid to store file123, but she knows that Bob is also storing that file, she might simply forward any file requests she receives to Bob. The blockchain platform defense against this attack is to require all data requests to go through the mining network. Since the cheater must pay the other blobbers for the data, this attack is not profitable for the cheater. Additionally, the mining network's blockchain gives some accounting information that can be analyzed to identify potential cheaters.

A Sybil attack is a kind of security threat on an online system where one person tries to take over the network by creating multiple accounts, nodes or computers. This can be as simple as one person creating multiple social media accounts. But in the world of cryptocurrencies, a more relevant example is where somebody runs multiple nodes on a blockchain network.

Another attack may occur if two blobbers collude, both claiming to store a copy of the same file. For example, Alice and Bob might both be paid to store file123 and file456. However, Alice might offer to store file123 and provide it to Bob on request, as long as Bob provides her with file456. In this manner, they may free up storage to make additional tokens. In essence, collusion attacks are outsourcing attacks that happen using back-channels. A Sybil attack in the context of storage is a form of collusion attack where Alice pretends to be both herself and Bob. The concerns are similar, but the friction in coordinating multiple partners goes away. The blockchain platform message flow-based model requires that the blobbers are assigned randomly for each transaction, helping to further reduce the chance of collusion.

The blockchain platform uses erasure codes to help defend against unreliable blobbers in a network. Furthermore, the blockchain platform makes demands on the capabilities of blobbers authorized to use the platform. For example, if it repeatedly underperforms expectations, a blabber's reputation may suffer, and risk being dropped from the network.

In another attack, a client might attempt to double-spend their tokens to acquire additional resources. However, the client is not given access to its resources until the transaction has been finalized. The blockchain platform transactions are designed for rapid finalization, so the delay for the client should be minimal. Other attacks such as fraudulent transactions are the purview of the mining protocol and the blockchain platform is well designed with defenses based on its robust implementations of authentication and data integrity modules. A replay attack also fails on the blockchain platform with the use of timestamps as one of the fields to assign unique transaction id.

Finally, generation attacks may arise if a blobber poses as a client to store data that they know will never be requested. By doing so, they hoped to be paid for storing this data without actually needing the resources to do so. The blockchain platform can defend against generation attacks with a challenge protocol that requires blobbers to periodically provide files that they store.

Locking System Resources. The message flow model for the blockchain platform is robust and resilient in locking system resources and reusing the same when resources are freed. For example, in order to store files, clients must use their tokens to purchase a certain amount of storage for a year. During this period, the clients' tokens are locked and cannot be sold. Likewise, to access or update their data, clients must purchase a certain number of reads and writes. To lock tokens, the client posts a transaction to the mining network. For example, the transaction includes the following without limitations: (i) the id of the client (client_id); (ii) the amount of storage (amt_storage); (iii) the number of reads (num_reads); (iv) the number of writes (num_writes); (v) a params field for any additional requirements allowing for flexibility. Only one of amt_storage, num_reads, and num_writes is required, since a client may be locking additional resources to supplement a previous transaction. However, the blockchain platform generally expects a client to lock all three in any transaction.

A person of ordinary skill in the art would understand that there are well-established methods and techniques to establish a secure digital connection between any two parties on the internet. The blockchain platform relies on the well-established methods to establish a secure connection with an added layer of security based on the role of the party i.e. the role of a client, a blobber or a miner. Neither the client nor the blobber trust one another, yet the blockchain platform allows both parties acting in its own best interest to nonetheless benefit each other. Any transgressions can be identified by the mining network of the blockchain platform with one or miners having the authority to punish any misbehaving party.

Creating a Connection. In establishing a connection, the blockchain platform performs the following: (i) assign blobbers to handle a client's request; and (ii) to ensure that the mining network knows what data the client wishes to store, allowing the network to police the client's and blobber's behavior. In one embodiment, the client and the blobber establish a session key between themselves. In another embodiment, the client and blobber set up a Transport Layer Security (TLS) connection instead of a session key.

A possible attack when creating a connection may include that a client might create a transaction on the mining network, but never send the data to the blobber, either as an attempt to damage a blabber's reputation or to prevent a blobber from being paid by other clients. On the blockchain platform, three factors mitigate this attack: (1) The client had to lock up tokens to perform this attack. In essence, they would be paying for storage without using it. (2) Blobbers are not challenged by the mining network until they post a transaction to finalize the data exchange. (3) Blobbers periodically monitor the blockchain for transactions involving them; if they notice this transaction, they can cancel it using an error reporting protocol.

Similarly, a blobber might not respond to the client and refuse to complete the connection. Again, several factors make this attack unlikely: (1) Once the connection is established, the client is expected to send markers. The blobber redeems these markers for tokens, and hence has a vested interest in completing the connection. (2) If the transaction times out, the client can report an error. (3) If the client becomes dissatisfied, they can delete their data from the blobber and reassign it to a different blobber. When this happens, the blobber is no longer paid for storing the data.

Reads and writes. After establishing a secure connection as described above, the blockchain platform performs reads and writes as described herein. Once a secure connection has been established between the client and the blobber, the client can choose to either read data from the blobber or update data stored with the blobber. The blockchain platform for uploading or downloading files requires that the client compensate the blobber. This process is done through the use of special read_marker and write_marker values created by the client. Each marker is a pair of a number (i) and a signature, where “i” is a counter starting at 0 that is incremented with each marker sent. READ and WRITE are constants included in the signatures denoting whether this is a read_marker or write_marker respectively.

The format of a read_marker is [READ, trans_id, blobber_id, block_num, client_id. The format of a write_marker is [WRITE, trans_id, blobber_id, hash(data), block_num, client_id, where hash(data) is the hash of the current block of data being sent. The blobber collects these markers, and when the transaction has either completed or timed out, the blobber writes a transaction to the blockchain effectively cashing in the markers in exchange for tokens. This transaction has the following effects: (i) The blobber is paid in tokens. (ii) The client loses the corresponding number of reads and writes. (iii) The Merkle root of the data (if it has been updated) is confirmed by the blobber. At this point, the blobber may be challenged to provide the data that they store. Since the blobber is also compensated for passing these challenges, they have a vested interest in completing the operation. Note that future transactions only allow access to the data if there is no discrepancy between the client and the blobber on the Merkle root of the data.

The information stored in the params field in message 1 depends upon the nature of the transaction. If this is a new file storage request, the k and n values for erasure coding must be included, since these settings affect the behavior of the network during challenges. Also, if this is a new file upload or a file update, the client must include the file size, the version number of the file, the fragment_id, chosen by the client, for this fragment of the erasure coded data.

Markers may serve as additional authorization tokens, and hence the double-spending problem is a concern. Blobbers might attempt to redeem a marker multiple times, or a client might attempt to pay different blobbers with the same marker. Each trans_id uniquely identifies the file involved, and the mining network does not accept markers if the trans_id does not match an existing transaction for an open connection. When the blobber redeems the markers, the connection is considered closed, and so the blobber cannot reuse the markers in a future transaction. Each marker must be unique within the redemption transaction, so the blobber is not able to double spend the marker within the transaction either. A client might attempt to pay multiple blobbers with the same marker. However, since both trans_id and blobber_id are included in the marker, this attack would fail.

If blobbers pose as clients, it is possible that they could generate markers without reading the data solely as a mechanism to get tokens. However, since the blobber would have to lock tokens to acquire reads, it would in some sense be paying itself with its own tokens.

Clients might create more markers than the number of reads and writes they have purchased, essentially writing checks that they cannot cash. Clients are expected to track the number of markers that they have used, and therefore are the best ones to hold accountable. On the blockchain platform, if a client exceeds the number of markers that they are authorized to create, the blobber is still paid. However, instead of paying the blobbers in newly-minted tokens, they are paid in tokens taken from the client. Other type of attacks might include a blobber ignoring a client's request for data and simply cash the marker's sent by the client. However, in this case the client would quickly stop sending markers to the blobber, preventing the blobber from receiving additional payment. Furthermore, the client would report an error to the network, and might decide to delete their data from the blobber. The blobber might send invalid data; however, the client might have the Merkle tree, in which case they would quickly spot the problem and report an error. Regardless, the blobber is expected to store the Merkle tree and can asked to provide it. The mining network stores the Merkle root, preventing the blobber from providing a false tree.

In scenarios where a client simply writes data, the blobber might not store the data. However, when redeeming markers, the blobber must confirm the new Merkle root. Therefore, the mining network would be able to catch the blabber's cheating with the challenge protocol. In another scenario, a client might send different data to the blobber that does not match the Merkle root specified in the blockchain, either in a hope to damage the blabber's reputation or to frustrate the blobber by using its resources without paying it. The blobber cannot finalize the transaction, and therefore will not be challenged (and paid) for storing the data. However, the blobber can report the error to the mining network. Furthermore, every write_marker includes a hash of the block of data sent, which can serve as a form of proof about what data the blobber received from the client.

Deleting Files. To delete a file, the client posts a transaction to the blockchain deleting the resource. Once the transaction is finalized on the blockchain, the client regains the storage allocation.

Blobbers are expected to poll the blockchain for these transactions. Once they notice that a file has been deleted, all blobbers storing slices of this data delete its data. In some attacks, a client might attempt to get free storage by a distributed denial of service attack (DDoS) the blobbers before they receive the message to delete the data, but the mining network would not approve future read requests. Clients might attempt to delete data, but maintain an open connection with blobbers. With this approach, the client would attempt to get free storage without needing to go through the mining network. A defense against this attack is that the mining network rejects all requests to delete data when there are open connections. If a blobber fails to close a connection, the client can report the error to the mining network and close the connection that way. Nothing on the blockchain platform enforces that the blobbers actually delete the data when asked though a blobber has little economic incentive to keep it. If the client is concerned about the confidentiality of its data, the client can encrypt its data before storage.

Challenge Request. In order to verify that a blobber is actually storing the data that they claim, the protocol relies on the miners periodically issuing challenge requests to the blobbers. The blockchain platform message flow model is also how blobbers are rewarded for storing files, even if the files are not accessed by any clients. When the blobber passes the challenge, it receives newly minted tokens. The mining network is responsible for establishing consensus on whether the blobber has passed the challenge. A transaction is posted by the mining network specifying which block of data is requested. The blobber sends the data to the mining network as well as the nodes of the Merkle tree needed to calculate the Merkle root. If the mining network reaches consensus that the blobber failed to provide the correct data in the allocated time, a transaction is posted punishing the blobber. Otherwise, a transaction is posted rewarding the blobber with the token. In one embodiment, an update to existing data may be canceled. The blobber might not have the correct data, and so cannot satisfy future challenges. Therefore, these cases are treated as delete transactions.

Recovering Data. There could be scenarios when the blockchain platform needs to recover data. When a blobber disappears unexpectedly from the network, or when a canceled transaction causes data to be lost, the data needs to be regenerated and stored with another blobber. In one embodiment, the repair operation is performed by the client, who will be required to get the needed slices, regenerate the new slice, and post a new transaction to store the regenerated slice. The cost of the transactions to recover the client's data is paid for by the client. However, if the loss is due to the misbehavior of a blobber, the blabber's stake may be seized and given to the client to help pay for the recovery.

If a client attempts to update data simultaneously with all blobbers, it is possible that all copies of the data could be deleted. In order to avoid this issue, the client can adjust the k and n values used in the erasure codes to provide greater resiliency and update the slices of data in sequence.

In one embodiment, the client must initially commit to the Merkle root of the data whenever a file is changed on the network. The result is that the transactions are either data writes or data reads. In one embodiment, the blockchain platform allows for reads and writes within a given client/blobber exchange. The client indicates the Merkle root is not yet known; when the blobber writes a transaction to cash their markers, they also commit to a Merkle root. The client can write a transaction on the blockchain either approving or contesting the Merkle root.

In one embodiment, the client can rebuild any data lost when a blobber goes offline unexpectedly. The client might not always be the best choice for this responsibility. If the client does not connect regularly, there might be a delay before they notice.

In one embodiment, when a blobber fails a challenge to provide a block of data, the mining network can initiate transactions to recover the missing fragment of data and reassign it to a different blobber. Any encryption by the client is performed before erasure coding to ensure that the data can be reconstructed without the client's aid.

Distributed Content Delivery Network. The blockchain platform using the message flow model can be used to geographically distribute data to increase the performance and availability of a client's data. A client may use encryption, distribute an application to reconstruct the data or use null encryption. The blockchain platform supports the ability for a client to stream content from a blobber.

On the blockchain platform, data blobs are identified by a combination of the client's unique id (client_id) and the client-chosen data_id. Individual transactions are assigned a trans_id based on the triple of these two fields and a timestamp (T). In addition to creating unique ids for transactions, the timestamp also ensures that each request is fresh and helps defend against replay attacks.

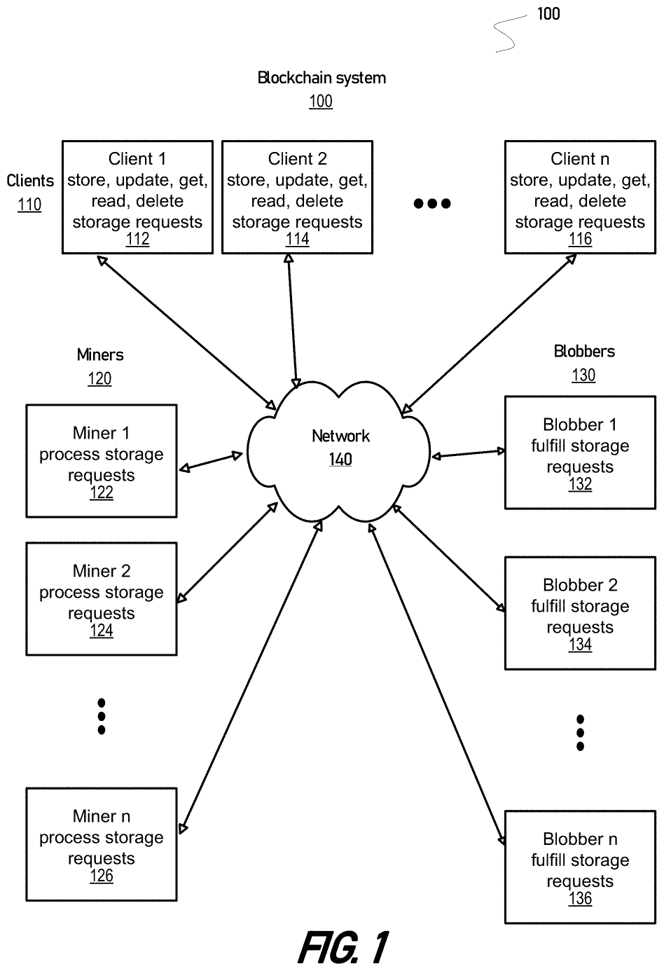

In one embodiment, FIG. 1 depicts a diagram 100 illustrating an example of a blockchain platform based on a message flow model for implementing different distributed applications. In the example of FIG. 1, the environment includes client 1 110, client 2 112, . . . , client n 114. The environment includes miner 1 120, miner 2, 122, . . . , miner n 124. The system includes blobber 1 130, blobber 2 132, . . . , blobber n 134. Each client system [110, 112, . . . , 114] may include components to store, update, get, read, write and/or delete requests. Although many clients, miners, and blobbers are supported, references to client 110, client system 110 or client device 110 will be used to indicate any selected client system. References to miner 120 or miner system 120 will be used to indicate a selected plurality of miners. References to blobber 130 or blobber system 130 will be used to indicate a selected plurality of blobbers. In an embodiment, any client system may include storage requests. A client can implement many types of flexible and distributed applications on the client system 110 using the client aspect of the blockchain platform using a message flow model. In the embodiment, the miner 120 includes components to process requests from the clients including storage requests. Two or more miners form a mining network. In the embodiment, the blobber 130 includes components to fulfill storage requests that are initiated by the client 110 and approved by miner 120.

Network 140 can be different wireless and wired networks available to connect different computer devices including client and server systems. In an implementation, network 140 is publicly accessible on the internet. In an implementation, network 140 is inside a secure corporate wide area network. In an implementation, network 140 allows connectivity of different systems and devices using a computer-readable medium. In an implementation, the blockchain platform using a message flow model allows users on the client system, the blobber or the miner to set privacy settings that allow data to be shared among select family and friends, but the same data is not accessible to the public. In an implementation, the blockchain platform using a message flow model allows users on the client system, the blobber or the miner to encrypt data to be shared among select family and friends, but the same data while available cannot be decoded by the public.

The messaging and notification between different components can be implemented using Application Programming Interface (API) calls, extensible markup language (“XML”) interfaces between different interfaces, Java/C++ object-oriented programming or simple web-based tools. Different components may also implement authentication and encryption to keep the data and the requests secure.

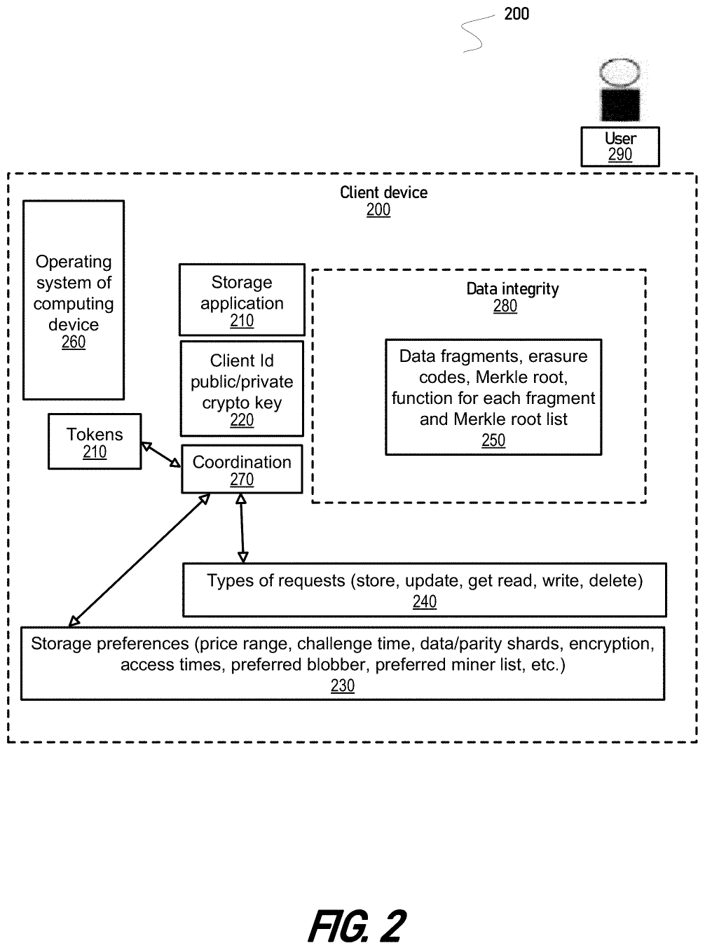

FIG. 2 depicts a client device 200 which is an exploded view of a client system 110 shown in FIG. 1. For a distributed storage application implementation, the client has a storage application 210 that interacts with the operating system 260 of the client device 200. In an example embodiment, the client computing device may have family photos, videos or business-related files for storage. The client device 200 may use the Diffie-Hellman key exchange method with another client, for example client 2 112. The Diffie-Hellman key exchange method allows two parties that have no prior knowledge of each other to jointly establish a shared secret key over an insecure channel, such as, network 140. This key can then be used to encrypt subsequent communications using a symmetric key cipher. The client uses a client_id 220 with a Diffie Hellman public and private cryptography keys to establish session keys. In one embodiment, the client and the blockchain platform uses Transport Layer Security, i.e. symmetric keys are generated for each transaction based on a shared secret negotiated at the beginning of a session. The client 200 gets preauthorized tokens 275 for storage allocation on the blockchain platform. The storage preferences for the client are coordinated using 270. A client's storage preferences 230 include price range, challenge time, data/parity shards, encryption, access times, preferred blobber, preferred miner lists, etc. Types of requests 240 include store, update, get, read, write and/or delete requests. The data integrity 280 includes techniques to create a hash based on available data, encryption of the data, division of data into fragments, use of erasure codes, Merkle root and Merkle tree creation based on data fragments and a Merkle root list for different types of data. A client may use one or more options in different types of combinations to preserve data integrity 280 verification when sending data out on the system to different blobbers on the blockchain platform. In one implementation, the client has an option to create its own data_id for selected data. In one implementation, the client gets an automatically generated data_id based on different client preferences and parameters of usages. A user 290 is shown using the client device 200. In one implementation, the client system includes module to report errors when a blobber does not send an anticipated message. In one implementation, the client system monitors the blockchain for different suspicious activities related to its own work.

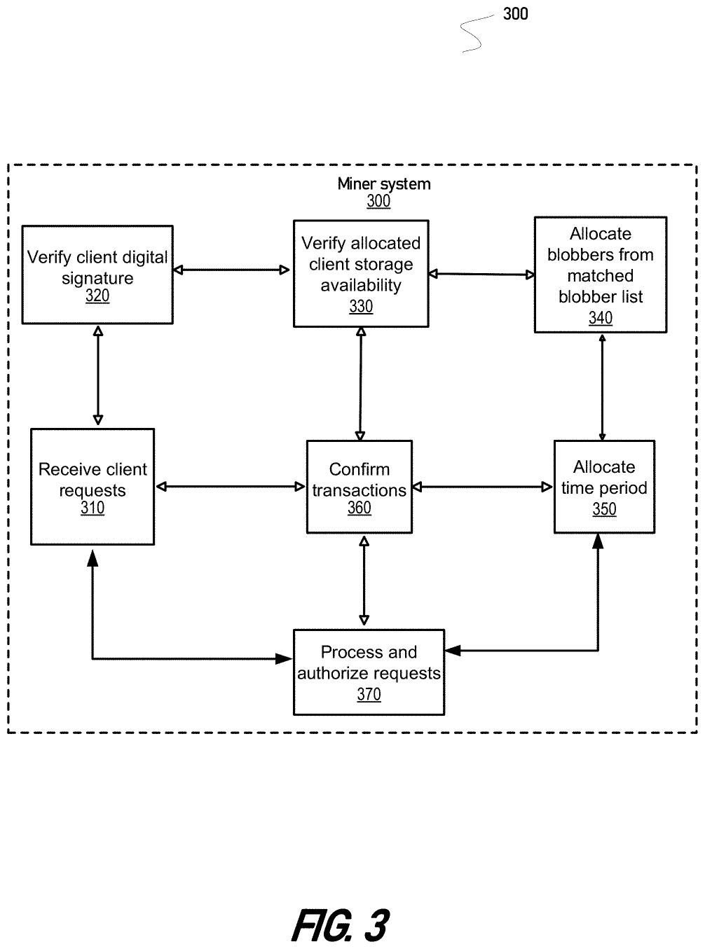

FIG. 3 depicts a miner system 300 which is an exploded view of a miner system 120 of FIG. 1. The different components or modules included in a miner system includes a module to process and authorize requests 370, receive client requests 310, verify client digital signature 320, verify whether client is allowed to make a particular request based on allocated storage for a client and availability on the system 330, allocate blobbers from a matched blobber list 340, allocate time period to complete the transaction 350, and confirm transaction 360 on the blockchain platform. In one embodiment, the miner system includes module to monitor the blockchain for different suspicious activities. In one embodiment, the miner system includes mechanism to handle error reports received from either a client or a blobber. In one embodiment, the miner system includes ranking or evaluations for clients and/or blobbers associated with the blockchain platform.

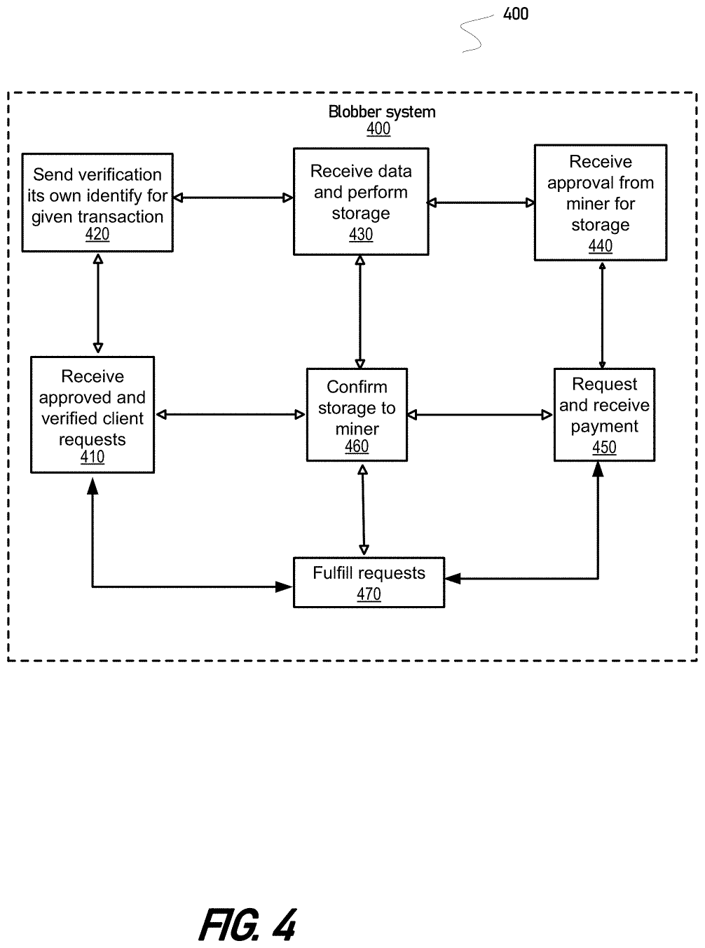

FIG. 4 depicts a blobber system 400 which is an exploded view of a blobber system 130 of FIG. 1. The different components or modules included in a miner system includes a module to fulfill requests 455, receive approved and verified client requests 420, send verification of its own identity for a given transaction 405, receive data and perform storage 410, receive approval and challenges from miner for storage 415, confirm storage to miner and validators 460, request and receive payment for storage and handling of the requests 450. In an embodiment, after a blobber has received approved and verified client requests 430, the blobber performs the required storage requests, that is, fulfills requests 455, collects validation tickets and submits the validation tickets to miners 435. The miner may challenge the blobber 430 at random. The miners pay blobbers from the challenge pool 440 after confirming storage to miner and validators 445 which supports a miner request for payment after which the miner receives payment 450. In one embodiment, the blobber system includes a module to report errors when a client does not send an anticipated message. In one embodiment, the blobber system monitors the blockchain for different suspicious activities related to its own work.

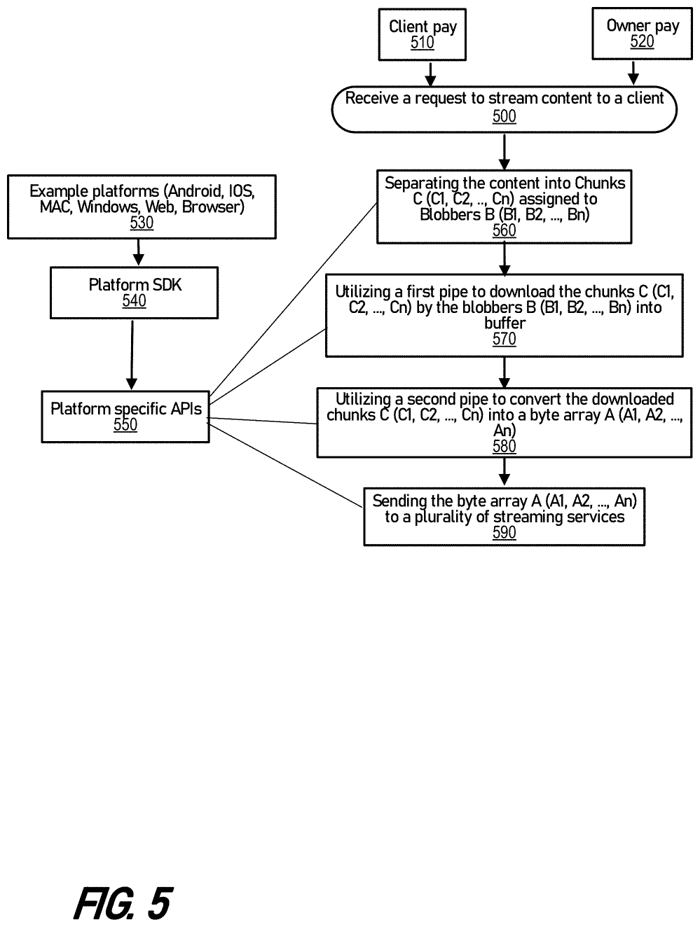

FIG. 5 depicts a flow of processes that support streaming content to a plurality of clients. Processing commences at 500 and shows the steps taken by a process that receive a request to stream content to a client. The process allows for client pay 510 and/or owner pay 520. The infrastructure for providing the support is provided via a platform software development kit (SDK) 540, Example platforms may include, but are not limited to Android, IOS, MAC, Windows, Web, Browser 530. Using the platform SDK 540, software is generated to provide platform specific APIS 550. At step 560, the content is separated into Chunks C (C1, C2, . . . , Cn) assigned to Blobbers B (B1, B2, . . . , Bn). At step 570, a first pipe is utilized to download the chunks C (C1, C2, . . . , Cn) by the blobbers B (B1, B2, . . . , Bn) into buffer. At step 580, a second pipe is utilized to convert the downloaded chunks C (C1, C2, . . . , Cn) into a byte array A (A1, A2, . . . , An). At step 590, the byte array A (A1, A2, . . . , An) is sent to a plurality of streaming services.

Different platforms may have different implementation. However, for most platforms zboxcli is wrapper to gosdk methods supported by a platform player. Unlike most streaming support, no server is required to supply the content. The content is downloaded by blocks where each block chunks may be coming from different blobbers, which are read and converted into a byte array, and sent to a player. A first pipe is used to read the content into a buffer and a second pipe is used to read from the buffer. Similarly, each platform or player may utilize two parallel pipes. In an embodiment with zboxcli commands, the file may be downloaded utilizing the downloadFileByBiocks method. The inputstream may be used to read the chunked foes into the byte array and AddByteArray may be used to customize the media source for the player. In an embodiment, downloadFileByBlocks returns file-chunks with correct byte range, using gosdk v1.2.4 and above only. getFileMeta, getFileMetaByAuth, and listAllocation returns actualBlockNumbers and actualFileSize (exclude thumbnail size.

Components to play video “on the fly” may include AVPlayer, which is a standard video player for IOS and Mac. ZChainPlayerItem extends from PlayerItem (AVKit framework). ZChainVideoFile is just a wrapper to communicate between AVPlayer and ZChain. When AVPlayer is started, ZChainPlayerItem starts chunked download, meantime AVPlayer requests for first chunk of video. When the first chunk arrives, player receives it through middleware buffer and starts requesting more chunks. It uses two parallel pipes with a middleware buffer, one pipe is from AVPlayer to read buffer, second pipe is from ZChain network to write chunks to buffer. If player cannot receive chunk (for example it is still not downloaded), then it will move to STALE state and user will see Video paused. During STALE state player still trying to request chunk few more times, if it's not yet received, then video will be stopped.

Components to play video “on fly” may include ExoPlayer which is a standard video player for Android. ZChainDataSource extends from BaseDataSource (ExoPlayer framework). ZChainFile is just a wrapper to communicate between ExoPlayer and ZChain. ZBoxCallback is a callback to communicate with gosdk and ZChainDataSource. When ExoPlayer is started, ZChainDataSource starts chunked download, meantime AVPlayer requesting for first chunk of video. When first chunk arrives, player receives it through middleware buffer and starts requesting more chunks. Basically, it uses 2 parallel pipes with middleware buffer, one pipe is from ExoPlayer to read buffer, second pipe is from ZChain network to write chunks to buffer.

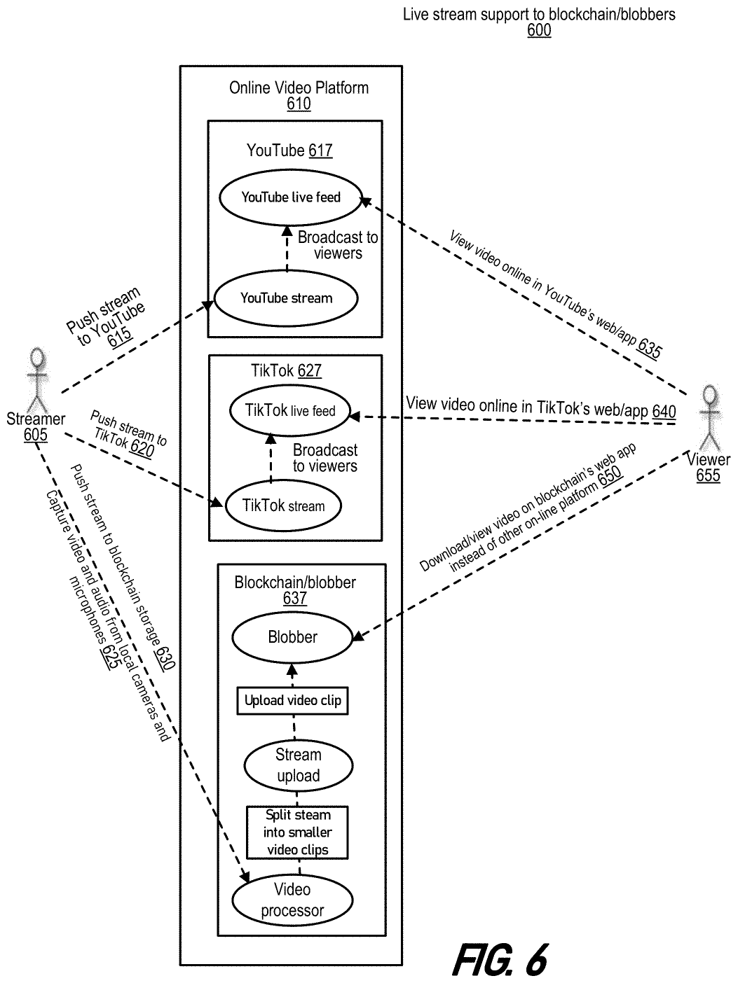

FIG. 6 depicts an embodiment supporting pushing a live stream to a blobber/blockchain 600. A streamer 605 configures content to be streamed continuously. Content may be streamed to an online video platform 610. The content may be captured video from local cameras and microphones 625 and streamed to a video processor, which may split the stream into smaller video cups and upload the video clip to a blockchain/blobber 637. In some embodiments, the content may be pushed or streamed to TikTok 620. TikTok 627 receives the live stream by TikTok stream support which broadcast to viewers via TikTok live feed. Content may be pushed or streamed to YouTube 615. YouTube 617 receives the live stream by YouTube stream support which broadcast to viewers via YouTube live feed. In an embodiment, local devices, such as, Internet of Things (IoT), cameras, microphones, and the like may continuously push stream data to the online video platform. A viewer 655 may view the streamed data via various services. The viewer 655 may view video online in YouTube's web/app 635. The viewer may view video online in TikTok's web/app 640. Alternatively, the viewer 655 may download/view video on blockchain's web/app instead of another on-line platform 650. continuously push or stream data to blockchain storage 630.

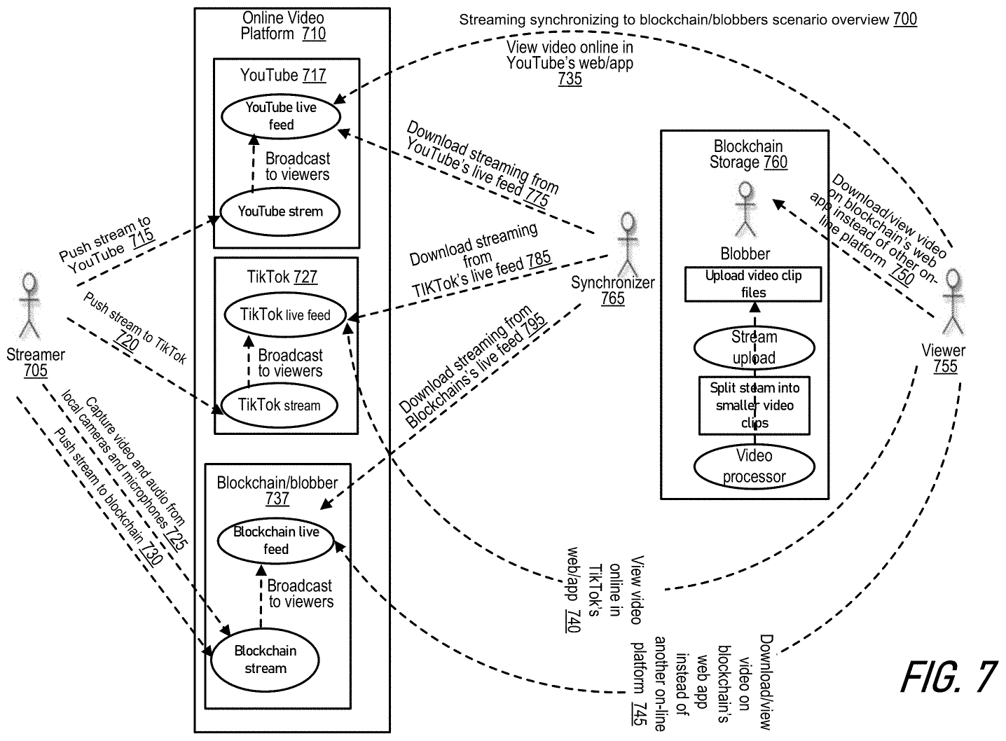

FIG. 7 depicts an overview of an embodiment supporting streaming synchronizing to blockchain/blobbers 700. A streamer 705 configures content to be streamed continuously. Content may be streamed to an online video platform 710. In an embodiment, local devices, such as, Internet of Things (IoT), cameras, microphones, and the like may continuously push stream data to the online video platform. The content may be captured video from local cameras and microphones 725 and streamed to a video processor, which may split the stream into smaller video clips and upload the video clip to a blockchain/blobber 737. In some embodiments, the streamer 705 pushes the stream to blockchain 730 which is configured to broadcast to viewers via a blockchain live feed. In some embodiments, the streamed content may be sent to the video processor which splits the stream into smaller video clips, forwards to stream upload with uploads video clip files to a blobber that stores the video clip utilizing blockchain storage 760. The viewer 755 may download/view video on blockchain's web app instead of other on-line platforms 750 by accessing blockchain storage 760. In some embodiments, the content may be pushed or streamed to TikTok 720. TikTok 727 receives the live stream by TikTok stream support which broadcast to viewers via TikTok live feed. In some embodiments, the content may be pushed or streamed to YouTube 715. YouTube 717 receives the live stream by YouTube stream support which broadcast to viewers via YouTube live feed. A viewer 755 may view the streamed data via various services. The viewer 755 may view video online in YouTube's web/app 735. The viewer may view video online in TikTok's web/app 740. Alternatively, the viewer 755 may download/view video on blockchain's web/app instead of another on-line platform 750. Blockchain's web/app may be configured to retrieve from the blockchain live feed or support may be provided to continuously push or stream data to blockchain storage 760 and retrieve from the blockchain storage 760. In an embodiment, a synchronizer 765 may retrieve content from the online video platform 710. The retrieved content may be from a service provider, such as, YouTube 717 and download streaming from YouTube's live feed 775. Alternatively, the retrieved content may be from TikTok 727 supported by downloading streaming from TikTok's live feed 785. The retrieved content may be from blockchain/blobber 737 by downloading stream from blockchain's live feed 795. A viewer 755 may download/view video on blockchain's web app instead of other on-line platforms 745. Support for synchronizing with the online video platform 710 may be supported in an embodiment by Application Programming Interfaces (APIs) that support pause, resume, and rewind.

In an embodiment, a blobber may have different hashes for a file. One hash may be a file hash used to verify a checksum of down loaded files on clients and provided by the client to the blobber. The hash of the original file may be identified as reference_objects.actual_file_hash in a database. A second hash, a content hash may be used to verify the checksum of uploaded data blocks on a blobber server. It is a hash of data blocks that is sharded by ErasureEncoder on client and uploaded by a blobber. The uploaded content hash may be identified as reference_objects.content_hash in a database. The content hash may be used as a challenge on validator-based challenge protocol. The content hash may be identified as reference_objects.merkle_root in a database. When recording data, a hash tree or Merkle tree may be recorded by the blobber. The Merkle tree is a tree in which every leaf node is labelled with the cryptographic hash of a data block, and every non-leaf node is labelled with the cryptographic hash of the labels of its child nodes. Creating a Merkle tree may be a performance bottleneck. A client may also calculate an original file hash, an uploaded content hash, and a Merkle tree hash.

In order to improve performance and prevent paging of blocks of memory undergoing complex algorithms, such as, SHA-256 hashing, a CompactMerkleTree approach is disclosed. The CompactMerkleTree is a MerkleTree in which nodes are labelled and removed as soon as possible.

In a typical MerkleTree embodiment, all leaf nodes are added and keep in memory before computing hashes. Hashes are computed from leaf nodes to root node level by level. In a CompactMerkleTree, hashes may be computed responsive to adding hashes of two child nodes. The combined result is stored as the binary hash on their parent node. After storing the combined result on their parent node, the two child nodes are no longer needed and may be removed from memory. In an embodiment, the size of a data block is chunk size. A data block can be released from memory once its hash is computed and added into MerkleTree as a leaf node. A block is characterized as “In Memory” if the block has to be kept in memory for computing hash. A block is characterized as “Out Memory” if the block is safe to release from memory or is not added to memory yet. CompactMerkleTree has a smaller footprint and supports more efficient processing than MerkleTree pertaining to persisting on disk or keeping in memory.

In an embodiment, actual file hash and content hash may be computed with sha1. Sha1 asks fully load content in memory before computing hash. It needs higher memory usage for large file. And it also blocks chunked upload feature. In MerkleTree, a file can be read and computed chunk by chunk.

Challenge Hash is also computed by MerkleTree. There is a need to make sure each storage server is doing their job and committing resources, rather than pretend to offer storage, instead of outsourcing it to another storage server. The disclosed protocol avoids this outsourcing attack by ensuring that the content provided for verification is 64 KB and the content required to create this verified content is the full file fragment. Although, alternative block sizes may be used, the example embodiment illustrates an exemplary embodiment. The file is divided into n 64 KB fragments based on n storage servers. Each of these 64 KB fragments is further divided into 64-byte chunks, so there are 1024 such chunks in each 64 KB block that can be addressed using an index of 1 to 1024. The data at each of these indexes across the blocks is treated as a continuous message and hashed. Then the 1024 hashes serve as the leaf hashes of the Merkle Tree. The root of this Merkle tree is used to roll up the file hashes further up to directory/allocation level. The Merkle proof provides the path from the leaf to the file root and from the file root to the allocation level. In this model, in order to pass a challenge for a file for a given index (between 1 and 1024), a dishonest storage server first needs to download all the content and do the chaining to construct the leaf hash. This discourages outsourcing the content and faking a challenge response. The fixed Merkle tree is a MerkleTree in which every leaf node is labelled with the MerkleTree hash of a data block, and every non-leaf node is labelled with the cryptographic hash of the labels of its child nodes. In an embodiment, the fixed Merkle has fixed 1024 leaf nodes. The size of the leaf nodes and the number of leaf nodes may be different in a different embodiment.

Regarding protection against an outsourcing attack, if the fixed Merkle tree is avoided, then the blobber could just store the Merkle tree, delete the data, and when there is a challenge, outsource a particular block from other blobbers, and send it to the validator along with the hash of the content. However, In the case of a fixed Merkle tree, the blabber would need to download the entire file, reconstruct the identified challenge block and the DAB content in order to have the correct hash for the Merkle tree. For a 1 TB file (video), the blobber would need to download the full file which will cost more than storing ft.

The Challenge Hash is a computed hash with MerkleTree in which every leaf node is labelled with sha3, and every non-leaf node is labelled with the cryptographic hash of the labels of its child nodes. Sha3 asks fully loaded block 1-n, block 2-n, . . . , block 1024-n in memory before computing hash for leaf node n. It has the same issue as sha1 in Actual File Hash and Content Hash. In an embodiment, every leaf node may be labelled with CompactMerkleTree instead of sha3.

In an embodiment, for the files, a structure like Git may be used. Each file is stored on the blobbers named according to the file's Merkle root. This means that every blobber will have a different name, since they are storing different slices of the same file. The files themselves are organized into directories. A directory stores a file mapping the user-friendly name of the file (e.g., “hello_world.txt” to its content hash (e.g., ae374f22071 . . . ), thereby telling it the name of the actual file with the data. The directory files themselves can be hashed in the same fashion, and essentially treated like the other files. The root of the directory structure is therefore a single hash that can validate the encrypted, encoded data that the blobber is storing. This is the hash that should be stored in the write marker. If the blabber cashes in the write marker, they are committing themselves to storing the system contents matching that hash.

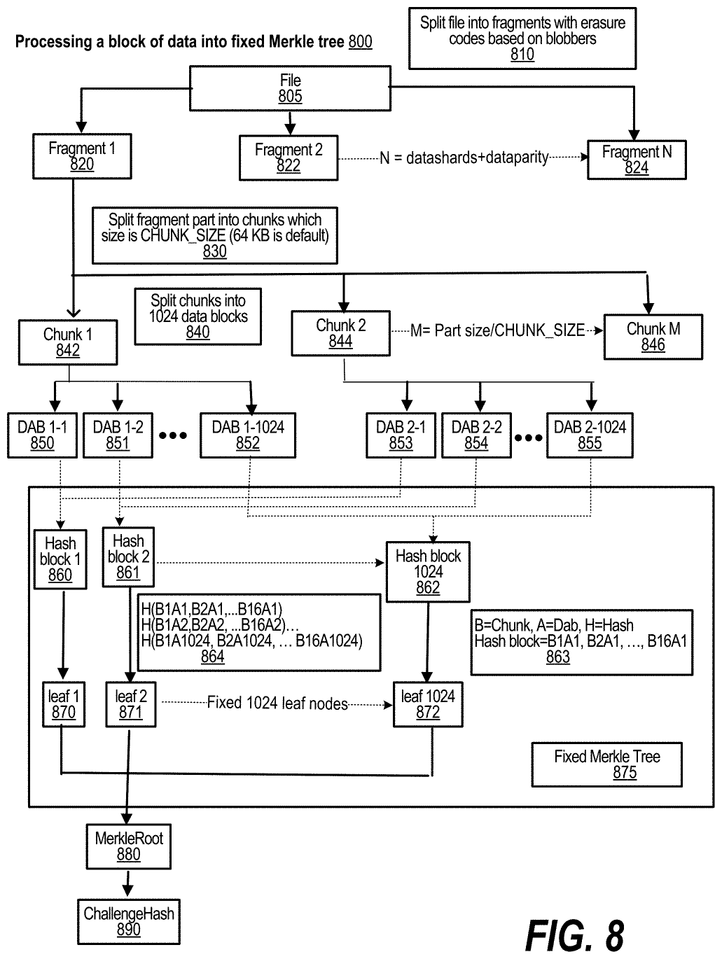

FIG. 8 depicts an overview of processing a block of data into a fixed Merkle tree 800. The file 805 is received into the system. At step 810, the process splits file 805 into fragments with erasure codes based on blobbers which are selected to store selected fragments. The number of fragments may be determined by the number of buffers allocated to hold the fragments. Without loss of generality, the fragments are ordered as received in the file and are numbered fragment 1 820, fragment 2 822, . . . , fragment N 824, where N=datashards+dataparity, which determine erasure coding characteristics. At step 830, the process splits each fragment part into chunks which size is CHUNK_SIZE (64 KB is default), chunk 1 842, chunk 2 844, . . . chunk M 846, where M=part size/CHUNK_SIZE. At step 840, the process splits chunks into 1024 data blocks, where chunk 1 842 is split into DAB 1-1 850, DAB 1-2 851, . . . , DAB 1-1024 852, chunk 2 844 is split into DAB 2-1 853, DAB 2-2 854, . . . , DAB 2-1024 855 continuing through chunk M 846. A fixed sized Merkle tree 875 is produced by constructing a fixed 1024 leaf nodes Merkle tree with leaf 1 870, leaf 2 871, . . . , leaf 2014 872. Each leaf corresponds to hash block 1 860, hash block 2 861, . . . , hash block 1024 862 corresponding to the DABs from each chunk, in this case, Chunk 1 842. Using the key B=chunk, A=DAB, H=hash, hash block=B1A1, B2A1, B16A1 863 and H(B1A1,B2A1, . . . B16A10, H(B1A2, B2A2, . . . , B16A2), H(B1A1024), B2A1014, . . . , B16A1024) 864. The MerkleRoot 880 is derived from the fixed 1024 leaf nodes and the challengehash 890 is supported by the fixed Merkle tree 875.

In an embodiment, the streaming content C (C1, C2, . . . , Ci, Ci+1, . . . ) is received into buffers in the blockchain platform. The buffered content is separated into fragments F (F1, F2, Fi, . . . Fn) where the each fragment Fi has a memory allocation different from other fragments Fj where j is not i while continuing to receive the streaming content until a blocking event occurs. Each fragment is split into a number of chunks determined by a fragment size divided by a chunk size. Each chunk is split into a fixed number of DABs where the number of DABs is the chunk size divided by the DAB size. A fixed Merkle tree is constructed suitable for sending to a number of blobbers for recording the DABs referenced by the leaf nodes of the fixed Merkle tree. In retrieving recorded content, a missing data fragment may be reconstructed by a blockchain data recovery algorithm when a first recorded data by a first blobber must be combined with a second recorded data by a second blobber using erasure code to re-construct the missing data fragment that needs to be sent to the third blobber, when the data is split between three blobbers.

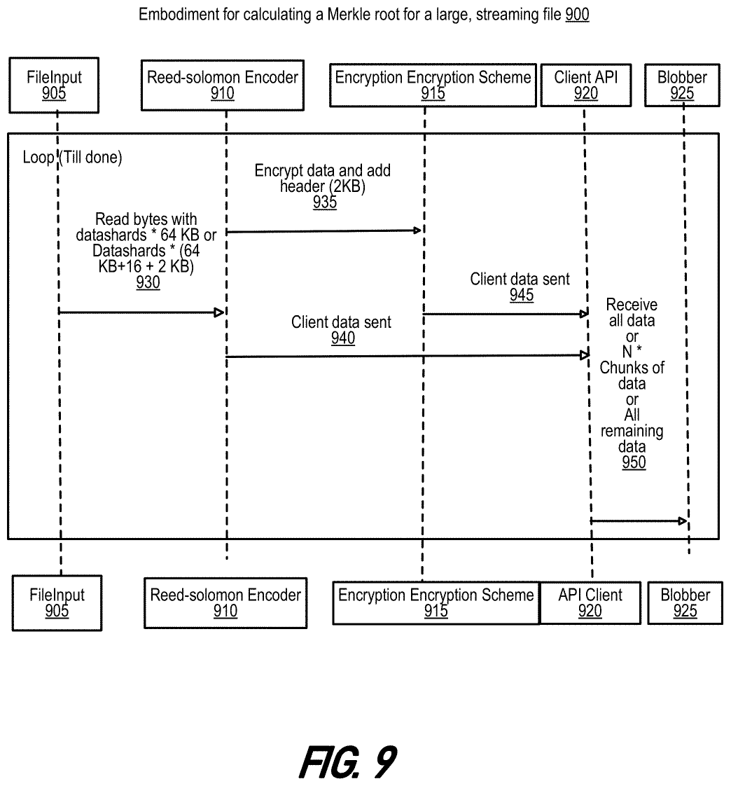

FIG. 9 depicts an overview of an embodiment for calculating a Merkle root for a large, streaming file 900. Filelnput 905 is the file input or streaming data. The process iteratively loops until no more data is received. At step 930, the process reads bytes from the Filelnput 905 separating by blocksize such as with datashards*64 KB or datashards*(64 KB+16+2 KB) These are fragments of a file which are encoded based on number of data and parity shards of the file and is encoded using reed-solomon encoder. The fragment is divided into chunks which can be 64 KB size. These separated data blocks are sent to the reed-solomon encoder 910. The reed-solomon Encoder 910 determines if the datablock needs encryption. If the data block needs encryption, then a 2 KB header is added and is forwarded to encryption encryption scheme 915. The encryption encryption scheme 915 may use proxy-reencryption to ensure client data is sent 945 through client API 920. If the datablock does not need encryption, then read-solomon encoder 910 takes the client data sent 940 and forwards the data directly to the client API 920. The client API 920 the forwards the data to the blobber 925. The blobber 925 receives one of: all data, N*chunks of data, or all remaining data 950.

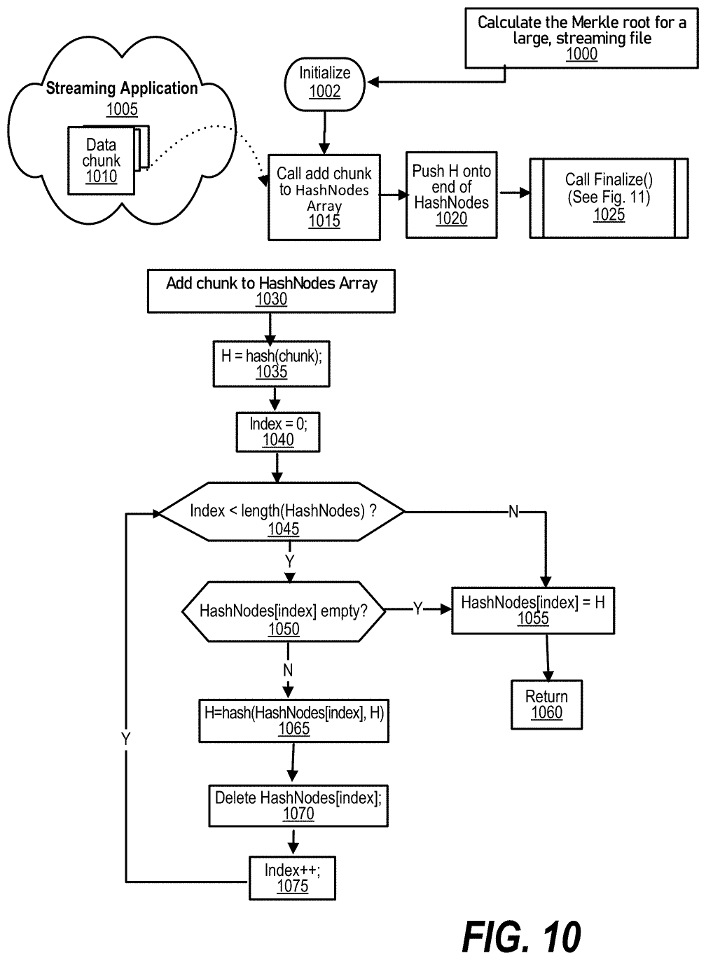

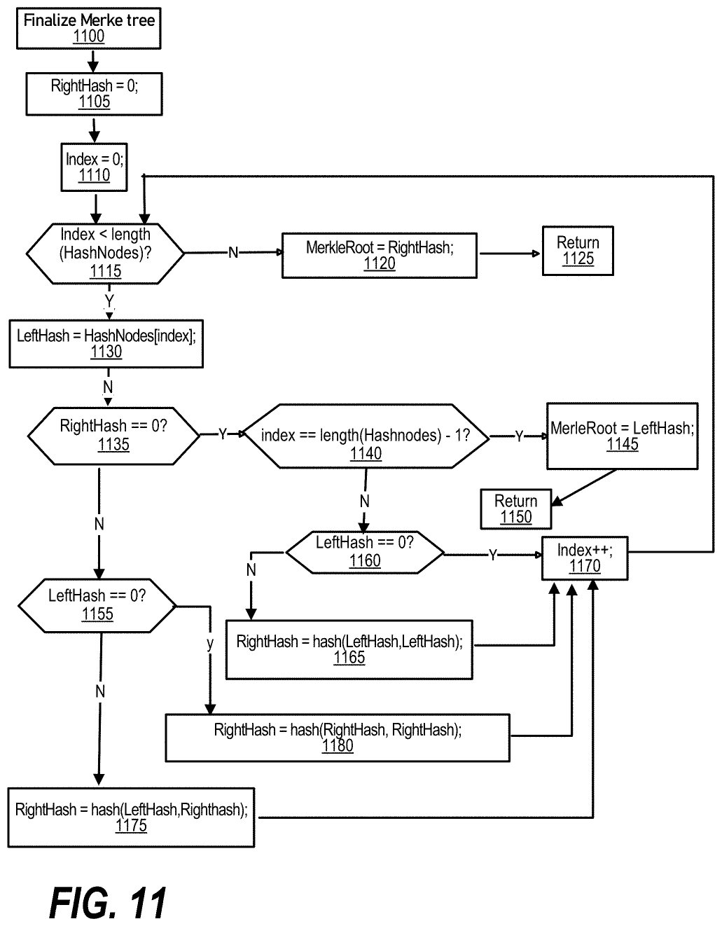

FIG. 10 processing commences at 1000 and shows the steps taken by a process that calculate the Merkle root for a large, streaming file. At step 1002, the process initializes the system, preparing the system to accept data chunks 1010 from a streaming application 1005. When data chunks 1010 are received, the process calls add chunk to HashNodesArray 1015. After returning from add chunk to HashNodesArray, the return value H is pushed onto the end of the HashNodes 1020. At predefined process 1025, the process performs the Call Finalization( ) routine (see FIG. 11 and corresponding text for processing details). At step 1030, the add chunk to HashNodes array is executed. At step 1035, H is set=hash(chunk). At step 1040, index is set=0. The process determines as to whether Index<length(HashNodes) (decision 1045). If Index<length(HashNodes), then decision 1045 branches to the ‘yes’ branch. On the other hand, if not Index<length(HashNodes), then decision 1045 branches to the ‘no’ branch. The process determines as to whether HashNodes[index] empty (decision 1050). If HashNodes[index] empty, then decision 1050 branches to the ‘yes’ branch. On the other hand, if not HashNodes[index] empty, then decision 1050 branches to the ‘no’ branch. At step 1055, the process sets hashNodes[index]=H. At step 1065, the process set H=hash(HashNodes[index], H]). At step 1070, the process deletes HashNodes[index]. At step 1075, the process sets index++ and branches to step 1045. At step 1060 the add chunk to HashNodesArray returns to the calling routine, which proceeds to step 1020.

FIG. 11 processing commences at 1100 and shows the steps taken by a finalize( ) process that finalizes a Merkle tree. The algorithm ensures that the Merkle tree is balanced. At step 1105, the process sets righthash=0. At step 1110, the process sets index=0. The process determines as to whether index<length (HashNodes) (decision 1115). If index<length (HashNodes), then decision 1115 branches to the ‘yes’ branch. On the other hand, if not index<length (HashNodes), then decision 1115 branches to the ‘no’ branch. At step 1120, the process sets merkleRoots=RightHash. FIG. 11 processing thereafter returns to the calling routine (see FIG. 10) at 1125. At step 1130, the process sets LeftHash=HashNodes[index]. The process determines as to whether RightHash==0 (decision 1135). If RightHash==0, then decision 1135 branches to the ‘yes’ branch. On the other hand, if not RightHash==0, then decision 1135 branches to the ‘no’ branch. The process determines as to whether index==length(Hashnodes)−1 (decision 1140). If index==length(Hashnodes)−1, then decision 1140 branches to the ‘yes’ branch. On the other hand, if not index==length(Hashnodes)−1, then decision 1140 branches to the ‘no’ branch. At step 1145, the process sets MerkleRoot=LeftHash. FIG. 11 processing thereafter returns to the calling routine (see FIG. 10) at 1150. The process determines as to whether LeftHash==0 (decision 1155). If LeftHash==0, then decision 1155 branches to the ‘yes’ branch. On the other hand, if not LeftHash==0, then decision 1155 branches to the ‘no’ branch. The process determines as to whether LeftHash==0 (decision 1160). If LeftHash==0, then decision 1160 branches to the ‘yes’ branch. On the other hand, if not LeftHash==0, then decision 1160 branches to the ‘no’ branch. At step 1165, the process sets RightHash=hash(LeftHash,Lefthash). At step 1170, the process sets index++. At step 1175, the process sets rightHash=hash(LeftHash,RightHash). At step 1180, the process sets RightHash=hash(RightHash,RightHash).

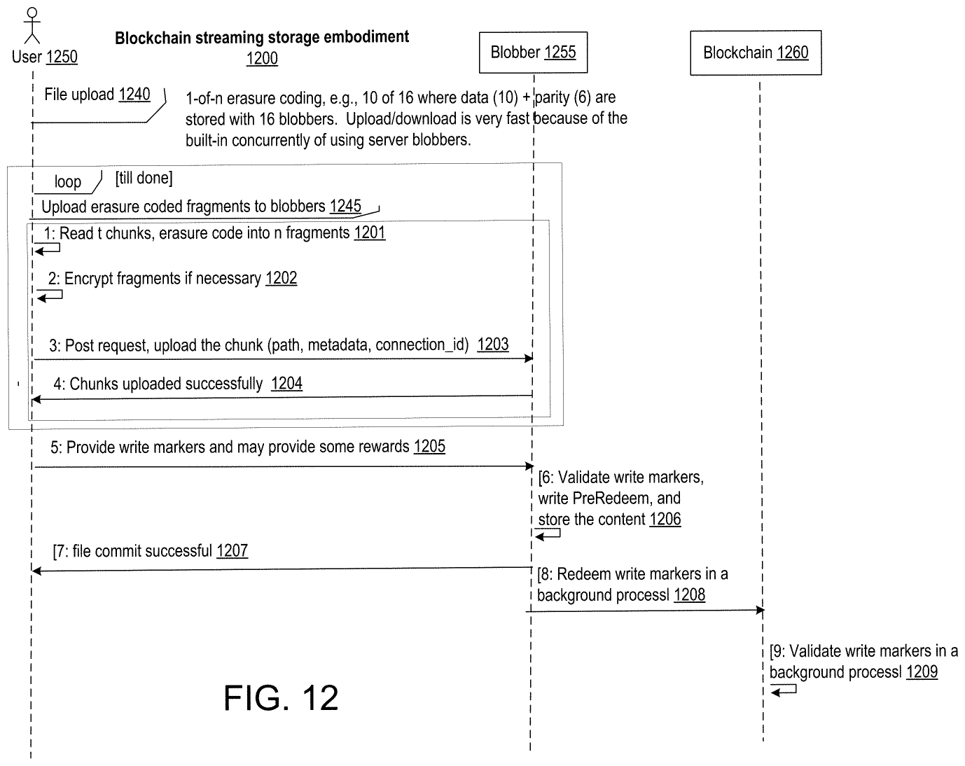

FIG. 12 processing commences at 1200 and shows the steps taken by an embodiment of a process handling blockchain streaming storage. A user 1250 has initiated a file upload 1240. In the disclosed embodiment, 16 blobbers receive portions of the streaming content. The system utilized 1-of-n erasure code coding. For example, 10 of 16 where 10 data are complemented with 6 parities stored with the blobbers. Due to the separation, upload/download speed is very fast because of the built-in concurrency of using server blobbers. The system loops till no more content are received utilizing upload erasure coded fragments to blobber at step 1245. At step 1201, the process reads t chunks, which are erasure coded into n fragments. At step 1202, the process, encrypts fragments if necessary. At step 1203, the process posts the request and uploads the chunk (path, metadata, connection_id). At step 1204, the process successfully uploads the chunks. At step 1205, the process provides write markers and may provide some rewards. At step 1206, the process validates write markers, writes PreRedeem, and stores the content. At step 1207, the process file commits successfully. At step 1208, the process redeems write markers in a background process! At step 1209, the process validates write markers in a background process. In this embodiment, a first recorded data by a first blobber must be combined with a second recorded data by a second blobber using erasure code to construct data split and sent to the first blobber and the second blobber. Concurrency is supported, for example a chunk is erasure coded into x data and y parity and sent to x+y blobbers currently with a separated and independently submitted and processed payment option.

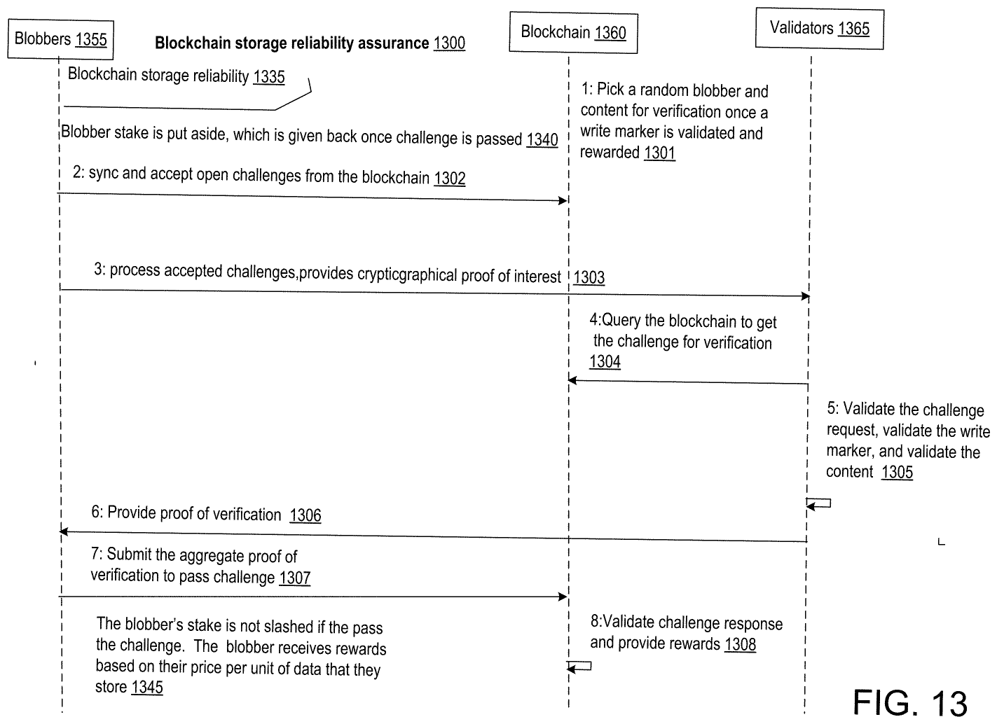

FIG. 13 processing commences at 1300 and shows the steps taken by a process that assures blockchain storage reliability. For this support at step 1340, the process puts aside the blobbers 1355 stake, which is given back once challenge is passed. At step 1301, the process picks a random blobber and content for verification once a write marker is validated and rewarded. At step 1302, the process syncs and accept open challenges from the blockchain. At step 1303, the process accepted challenges and provides cryptographical proofs of interest. At step 1304, the process queries the blockchain to get the challenge for verification. At step 1305, the process validates the challenge request, validates the write marker, and validate the content. At step 1306, the process provides proof of verification. At step 1307, the process submits the aggregate proof of verification to pass the challenge. At step 1308, the process validates challenge response and provide rewards. At step 1345, the process ensures the blobber's stake is not slashed if they pass the challenge. The blobber receives rewards based on their price per unit of data that they store. Signed write markers are validated and a randomly challenged blobber is rewarded based on a successfully validated outcome of a challenge and response analysis. The randomly challenged blobber is penalized based on a failed outcome of a challenge and response analysis.

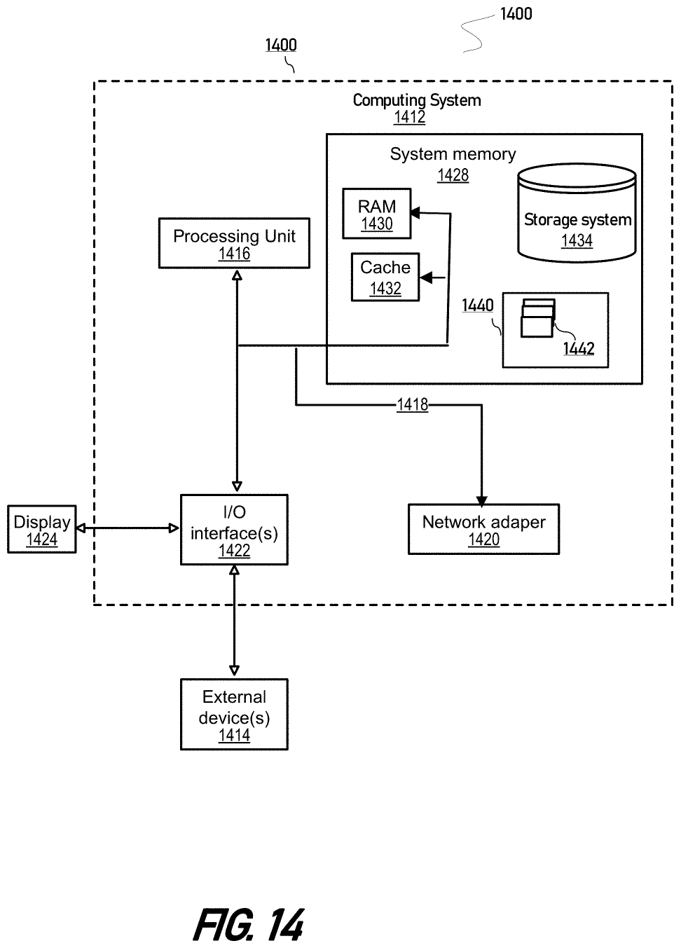

Referring to FIG. 14, a schematic view of a processing system 1400 is shown wherein the methods of this invention may be implemented. The processing system 1400 is only one example of a suitable system and is not intended to suggest any limitation as to the scope of use or functionality of embodiments of the invention described herein. Regardless, the system 1400 can implement and/or performing any of the functionality set forth herein. In the system 1400 there is a computer system 1412, which is operational with numerous other general purpose or special purpose computing system environments or configurations. Examples of well-known computing systems, environments, and/or configurations that may be suitable for use with the computer system 1412 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system 1412 may be described in the general context of computer system-executable instructions, such as program modules, being executed by a computer system. Generally, program modules may include routines, programs, objects, components, logic, data structures, and so on that perform tasks or implement abstract data types. The computer system 1412 may be practiced in distributed cloud computing environments where tasks are performed by remote processing devices that are linked through a communications network. In a distributed cloud computing environment, program modules may be in both local and remote computer system storage media including memory storage devices.

As shown in FIG. 14, the computer system 1412 in the system environment 1400 is shown in the form of a general-purpose computing device. The components of the computer system 1412 may include, but are not limited to, a set of one or more processors or processing units 1415, a system memory 1428, and a bus 1418 that couples various system components including the system memory 1428 to the processor 1415.

The bus 1418 represents one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA) bus, the Micro Channel Architecture (MCA) bus, the Enhanced ISA (EISA) bus, the Video Electronics Standards Association (VESA) local bus, and the Peripheral Component Interconnects (PCI) bus.

The computer system 1412 typically includes a variety of computer system readable media. Such media may be any available media that is accessible by the computer system 1412, and it includes both volatile and non-volatile media, removable and non-removable media.

The system memory 1428 can include computer system readable media in the form of volatile memory, such as random-access memory (RAM) 1430 and/or a cache memory 1432. The computer system 1412 may further include other removable/non-removable, volatile/non-volatile computer system storage media. By way of example only, a storage system 1434 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 1418 by one or more data media interfaces. As will be further depicted and described below, the system memory 1428 may include at least one program product having a set (e.g., at least one) of program modules 1442 that are configured to carry out the functions of embodiments of the invention.

A program/utility 1440, having the set (at least one) of program modules 1442, may be stored in the system memory 1428 by way of example, and not limitation, as well as an operating system, one or more application programs, other program modules, and program data. Each of the operating systems may have one or more application programs, other program modules, and program data or some combination thereof, and may include an implementation of a networking environment. The program modules 1442 generally carry out the functions and/or methodologies of embodiments of the invention as described herein.

The computer system 1412 may also communicate with a set of one or more external devices 1414 such as a keyboard, a pointing device, a display 1424, a tablet, a digital pen, etc. wherein these one or more devices enable a user to interact with the computer system 1412; and/or any devices (e.g., network card, modem, etc.) that enable the computer system 1412 to communicate with one or more other computing devices. Such communication can occur via Input/Output (I/O) interfaces 1422. These include wireless devices and other devices that may be connected to the computer system 1412, such as, a USB port, which may be used by a tablet device (not shown). Still yet, the computer system 1412 can communicate with one or more networks such as a local area network (LAN), a general wide area network (WAN), and/or a public network (e.g., the Internet) via a network adapter 1420. As depicted, a network adapter 1420 communicates with the other components of the computer system 1412 via the bus 1418. It should be understood that although not shown, other hardware and/or software components could be used in conjunction with the computer system 1412. Examples include, but are not limited to microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method that includes a processor and a local storage device accessible by the processor for streaming content into a plurality of blobbers running on a blockchain storage platform comprising:
receiving streaming content C (C1, C2, Ci, Ci+1, . . . );
storing the received streamed content C (C1, C2, Ci, Ci+1, . . . ) into a plurality of buffers;
separating the buffered content into fragments F (F1, F2, . . . , Fn) wherein the each Fi has a memory allocation different from other fragments Fj where j is not i while continuing to receive the streaming content until a blocking event occurs;
splitting each fragment into a number of chunks determined by a fragment size divided by a chunk size;
splitting each chunk into a fixed number of DABs where the number of DABs is the chunk size divided by the DAB size; and
constructing a fixed Merkle tree suitable for sending to a plurality of blobbers for recording the DABs referenced by the leaf nodes of the fixed Merkle tree.

2. The method of claim 1, wherein responsive to recording a hash of a DAB in a leaf node in the fixed Merkle tree, identifying the DAB as replaceable.

3. The method of claim 2, wherein the identified replaceable DAB is freed.

4. The method of claim 2, wherein a received Fi+n fragment targeted for replacing Fi in the Fi memory allocation triggers the blocking event until a hash of the DAB at the Fi memory allocation is recorded in a corresponding leaf leaf node of the fixed Merkle tree.

5. The method of claim 1, wherein responsive to recording a hash of child node in a parent node in the fixed Merkle tree, identifying the child node as replaceable.

6. The method of claim 5, wherein the identified replaceable child node is freed.

7. The method of claim 1, wherein the Merkle root is balanced based on entries in the HashNodes array.

8. The method of claim 1, wherein the streamed content is paused for a period of time and resumed after the period of time.

9. The method of claim 1, wherein a missing data fragment is included in a data split between three blobbers and the method further comprises:
combining a first recorded data by a first blobber with a second recorded data by a second blobber utilizing erasure encoding to reconstruct the missing data fragment; and
sending the missing data fragment by blockchain data recovery algorithm to a third blobber.

10. The method of claim 1, wherein a client calculates an original file hash, an uploaded content hash, and a Merkle tree hash.

11. The method of claim 1, wherein the chunk is erasure coded into x data and y parity and sent to x+y blobbers currently with a separated and independently submitted and processed payment option.

12. The method of claim 11, wherein the erasure coded chunk is encrypted.

13. The method of claim 11, wherein signed write markers are validated and a randomly challenged blobber is rewarded based on a successfully validated outcome of a challenge and response analysis.

14. The method of claim 11, wherein signed write markers are validated and a randomly challenged blobber is penalized based on a failed outcome of a challenge and response analysis.

15. The method of claim 1, further comprising:
receiving data from a live camera webapp by a video processor wherein the received data is split into smaller clips; and uploaded to one or more blobbers.

16. The method of claim 15, further comprising:
providing a blockchain web application allowing a viewer to view the uploaded data; and
responsive to the viewer utilizing the web application, downloading the uploaded data, and presenting the downloaded data to the viewer.

17. The method of claim 16, wherein the web application supports pause, resume, and rewind options; and
responsive to receiving viewer selections, presenting the data based on the viewer selections.

18. The method of claim 1, further comprising:
receiving streaming data from an intermediary server by a video processor;
splitting the streamed data into smaller video clips;
uploading the smaller video clips into a plurality of blobbers running on a blockchain storage platform.

19. The method of claim 18, further comprising:
providing a blockchain web application allowing a viewer to view the uploaded data; and
responsive to the viewer utilizing the web application, downloading the uploaded data, and presenting the downloaded data to the viewer.

20. The method of claim 19, wherein the web application supports pause, resume, and rewind options; and
responsive to receiving viewer selections, presenting the data based on the viewer selections.

21. The method of claim 1, wherein a challenge block against the fixed Merkle tree with deleted data requires a blobber to download an entire segment to reconstruct the challenge block and the DAB contents for the challenge block in order to have the correct hash for the fixed Merkle tree.
